(19) United States
(12) Patent Application Publication
(10) Pub. No.: US 2024/0036156 A1
(43) Pub. Date: Feb. 1, 2024

(54) PATCH ARRAY ANTENNA, AN ANTENNA, AND A RADAR APPARATUS

(71) Applicant: Furuno Electric Co., Ltd., Nishinomiya-City (JP)

(72) Inventor: Kenichi IIO, Nishinomiya (JP)

(73) Assignee: Furuno Electric Co., Ltd., Nishinomiya-City (JP)

(21) Appl. No.: 18/380,200

(22) Filed: Oct. 16, 2023

Related U.S. Application Data
(63) Continuation of application No. PCT/JP2022/010260, filed on Mar. 9, 2022.

(30) Foreign Application Priority Data
Jun. 21, 2021 (JP) 2021-102129

(51) Int. Cl. G01S 7/03; H01Q 21/08; H01Q 9/04

(52) U.S. Cl. CPC G01S 7/03; H01Q 21/08; H01Q 9/045

(57) ABSTRACT

A patch array antenna, an antenna, and a Radio Detecting and Ranging (RADAR) apparatus are disclosed. The patch array antenna is provided with a dielectric substrate and a plurality of antenna elements formed on the dielectric substrate. The patch array antenna is arranged in a first direction (longitudinal direction L) and connected in series. At least one terminal of at least one input terminal and at least one output terminal connected to at least one antenna element among the plurality of antenna elements is connected at a position away from the centerline extending in the first direction of the antenna element. The antenna includes a plurality of patch array antennas and the RADAR apparatus is formed using the antenna.

### CROSS-REFERENCE TO THE RELATED APPLICATION(s)

This application is a continuation application of PCT International Application No. PCT/JP2022/010260, which was filed on Mar. 9, 2022, and which claims priority to Japanese Patent Application No. JP2021-102129 filed on Jun. 21, 2021, the entire disclosures of each of which are herein incorporated by reference for all purposes.

### TECHNICAL HELD

The present disclosure generally relates to object detection techniques and, more particularly relates, to a patch array antenna, an antenna, and a Radio Detecting and Ranging (RADAR) apparatus.

### BACKGROUND

Moving bodies in the marine environment such as vessels, ships, barges, boats, etc. are typically used for the transportation of people and goods among other various applications, across the globe. Apparatuses used in the detection, ranging, and monitoring, such as Radio Detecting and Ranging (RADAR) and Sound Navigation and Ranging (SONAR) systems installed on-board moving bodies or stationary monitoring stations, are used to identify other moving and stationary objects in marine environments.

A patch antenna is a type of antenna consisting of a planar rectangular, circular, triangular, or any geometrical sheet of metal called a “patch”, mounted over a larger sheet of metal called a ground plane. A plurality of antenna elements (patches) are arranged in series on the ground plane, to form a patch array antenna. An antenna can be formed using two or more patch array antennas. One or more patch array antennas act as a transmitter antenna while other patch array antennas act as a receiver antenna. The antenna is installed on the RADAR or SONAR apparatus. Such apparatuses transmit electromagnetic (in RADAR) or sound pressure (in SONAR) waves through the transmitter antenna, sweeping the marine environment for other objects or bodies. The electromagnetic or sound pressure waves are reflected from a target object, for example, a target ship or a vessel. The reflected electromagnetic or sound pressure waves received by the aforementioned apparatuses (through the receiver antenna) are called echoes. Using the echo information, the location, the direction, the translational speed, etc. of the target object can be determined by the concerned apparatuses, such as the RADAR or the SONAR.

Chinese Patent No. CN 106972244 issued to Huizhou Speed Wireless Technology Co Ltd, discloses a vehicle-mounted RADAR array antenna. The vehicle-mounted RADAR array antenna includes a radiation sheet array and an impedance matching network. The radiation sheet array and the impedance matching network are arranged on the same plane, and the radiation sheet array is in a bilaterally symmetrical arrangement structure by taking the impedance matching network as a central axis. The antenna adopts a feed network, based on the impedance matching and phase shift principle of the microstrip line, realizes the related parameter requirements of the antenna radiation array in a simple implementation form, and further realizes the optimization of products. Simulation and antenna sample debugging of the vehicle-mounted anti-collision RADAR array antenna are convenient and fast. The microstrip impedance matching network and the array antenna are arranged in the same plane, so that the profile of the whole RADAR antenna is reduced, and the duty ratio of an antenna feed part in the whole vehicle-mounted. RADAR is effectively compressed. This design concept and method can break through the traditional complicated feed power division network structure on the back, effectively reduce the electromagnetic interference on other radio frequency devices, and have profound commercial application value in practical engineering.

European Patent No, EP 106972244 B1 issued to Huizhou Speed Wireless Technology Co Ltd, discloses a patch array antenna available in a millimeter frequency band, and an apparatus for transmitting and receiving a RADAR signal. A series-fed patch array antenna modifies a width of a feeder to secure a side lobe level without changing a radiator and an apparatus for transmitting and receiving a RADAR signal.

The conventional series feeding type patch antennas described in the above prior arts, generate a standing wave over an entire antenna. Such an antenna requires a design that considers both the power supplied from a center towards an end and the power bouncing off from the ends and flowing in the opposite direction. In addition, the amount of phase shift of the antenna elements also requires strict adjustment, and such adjustment affects the quantity of radiation of each antenna element. For this reason, it is difficult to control the desired weighting of the quantity of radiation of each antenna element.

Therefore, a need exists a need for an improved patch array antenna, the antenna, and the Radio Detecting and Ranging (RADAR) apparatus that can control the weighting of the quantity of radiation of each antenna element.

### SUMMARY

In order to solve the foregoing problem and to provide other advantages, one aspect of the present disclosure is a patch array antenna. The patch array antenna is provided with a dielectric substrate and a plurality of antenna elements formed on the dielectric substrate. The patch array antenna is arranged in a first direction (longitudinal direction L) and connected in series. At least one terminal of at least one input terminal and at least one output terminal connected to at least one antenna element among the plurality of antenna elements is connected at a position away from the centerline extending in the first direction of the antenna element. The antenna includes a plurality of patch array antennas. A Radio Detecting and Ranging (RADAR) apparatus is formed using the antenna.

An advantage of various embodiments is that the number and different positions of the input terminal and the output terminal of the patch array antenna allow easy control of the weighting of the quantity of radiation of each antenna element and suppress the generations of unwanted mode.

In an aspect, a patch array antenna including a dielectric substrate and a plurality of antenna elements is disclosed. The plurality of antenna elements is formed on the dielectric substrate, arranged in a first direction (e.g. longitudinal direction), and connected in series. At least one terminal of at least one input terminal and at least one output terminal connected to at least one antenna element of the plurality of antenna elements is connected at a position outside the centerline extending in the first direction (e.g. longitudinal direction) of the at least one antenna element.

Another aspect of the present disclosure is to provide an antenna including a transmitting antenna and a receiving antenna is disclosed. The transmitting antenna is configured to transmit electromagnetic waves around a Radio Detecting and Ranging (RADAR) apparatus. The receiving antenna is configured to receive electromagnetic waves reflected from one or more objects. At least one or more of the plurality of patch array antennas together form at least one of the transmitting antenna and the receiving antenna. Each of the plurality of the patch array antenna has a dielectric substrate and a plurality of antenna elements is disclosed. The plurality of antenna elements is formed on the dielectric substrate, arranged in a first direction (e.g. longitudinal direction), and connected in series. At least one terminal of at least one input terminal and at least one output terminal connected to at least one antenna element of the plurality of antenna elements is connected at a position outside the centerline extending in the first direction (e.g. longitudinal direction) of the at least one antenna element.

Yet another aspect of the present disclosure is to provide a Radio Detecting and Ranging (RADAR) apparatus that has an antenna and a controller. The antenna has a transmitting antenna and a receiving antenna. The transmitting antenna is configured to transmit electromagnetic waves around the RADAR apparatus. The receiving antenna is configured to receive electromagnetic waves reflected from one or more objects. At least one or more of the plurality of patch array antennas together form at least one of the transmitting antenna and the receiving antenna. Each of the plurality of the patch array antenna has a dielectric substrate and a plurality of antenna elements is disclosed. The plurality of antenna elements is formed on the dielectric substrate, arranged in a first direction (e.g. longitudinal direction), and connected in series. At least one terminal of at least one input terminal and at least one output terminal connected to at least one antenna element of the plurality of antenna elements is connected at a position outside the centerline extending in the first direction (e.g. longitudinal direction) of the at least one antenna element. The controller is configured to control one or more detection and ranging operations of the RADAR apparatus based on the reflected electromagnetic waves received by the receiving antenna.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device, or a tool and instrumentalities disclosed herein. Moreover, those skilled in the art will understand that the drawings are not to scale.

FIG. 1A illustrates a top view of an example representation of a patch array antenna, in accordance with a first embodiment of the present disclosure;

FIG. 1B illustrates an enlarged view of an antenna element with feeder lines and input/output terminals in the patch array antenna of FIG. 1A, in accordance with the first embodiment of the present disclosure;

FIG. 2A illustrates a schematic diagram showing the working of the patch array antenna of standing wave type, in accordance with the first embodiment of the present disclosure;

FIG. 2B illustrates a schematic diagram showing the working of the patch array antenna of FIG. 1A, in accordance with the first embodiment of the present disclosure;

FIG. 3A illustrates an enlarged view of an example representation of an antenna element with the feeder line and input/output terminals, in accordance with the first embodiment of the present disclosure;

FIG. 3B illustrates a graph showing the frequency characteristics of antenna elements, in accordance with the first embodiment of the present disclosure;

FIG. 4 illustrates a top view of another example representation of a patch array antenna, in accordance with a first embodiment of the present disclosure;

FIG. 5A illustrates a top view of an example representation of a patch array antenna, in accordance with a second embodiment of the present disclosure;

FIG. 5B illustrates an enlarged view of an antenna element with feeder lines and input/output terminals in the patch array antenna of FIG. 5A, in accordance with the second embodiment of the present disclosure;

FIG. 6A illustrates an enlarged view of an example representation of an antenna element with the feeder line and input/output terminals, in accordance with the second embodiment of the present disclosure;

FIG. 6B illustrates a graph showing the frequency characteristics of antenna elements, in accordance with the second embodiment of the present disclosure;

FIG. 7A and FIG. 7B illustrate calculation results of the directivity of the eight-stage patch array antenna shown in FIG. 5A, in accordance with the second embodiment of the present disclosure;

FIG. 8 illustrates a top view of another example representation of a patch array, antenna; in accordance with a second embodiment of the present disclosure;

FIG. 9A illustrates a calculation result of the directivity of the ten-stage patch array antenna shown in FIG. 8, in accordance with the second embodiment of the present disclosure;

FIG. 9B illustrates a graph showing the frequency characteristics of antenna elements, in accordance with the second embodiment of the present disclosure;

FIG. 10A illustrates a top view of an example representation of a patch array antenna, in accordance with a preferred embodiment of the present disclosure;

FIG. 10B illustrates a top view of another example representation of a patch array antenna, in accordance with a preferred embodiment of the present disclosure;

FIG. 11 shows an example representation of an antenna, in accordance with a preferred embodiment of the present disclosure; and

FIG. 12 shows an example representation of a RADAR apparatus, in accordance with a preferred embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments described herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an Application-Specific Integrated Circuit (ASIC), a Field Programmable Gate Array (FPGA), or other programmable device that performs logic operations without processing computer-executable instructions. A processor can also be implemented as a combination of computing devices, a combination of a Digital Signal Processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry, or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements, and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements, or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated” and other such relational terms should be construed, unless otherwise noted, to include removable, moveable, fixed, adjustable, and/or releasable connections or attachments. The connections/attachments can include direct connections and/or connections having an intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

Various embodiments of the present disclosure relate to a patch array antenna. The patch array antenna is provided with a dielectric substrate and a plurality of antenna elements formed on the dielectric substrate. The patch array antenna is arranged in a first direction (longitudinal direction L) and connected in series. At least one terminal of at least one input terminal and at least one output terminal connected to at least one antenna element among the plurality of antenna elements is connected at a position away from the centerline extending in the first direction (L) of the antenna element.

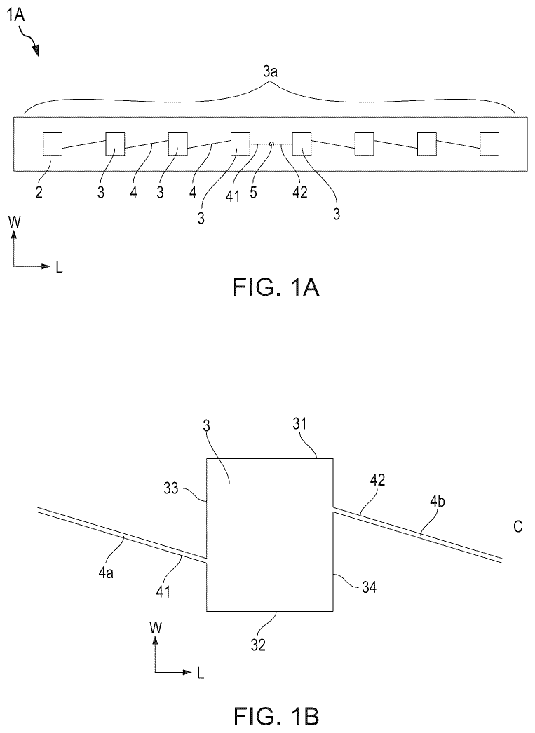

Various embodiments of the present disclosure also relate to an antenna and a RADAR apparatus. The antenna includes a plurality of patch array antennas. The RADAR apparatus includes the antenna and a controller. The antenna includes one or more transmitting antennas and one or more receiving antennas. The transmitting antennas transmit electromagnetic waves around the RADAR apparatus and receiving antennas receive the electromagnetic waves reflected from the target object. The controller performs one or more detection and ranging operations using the signals received (reflected electromagnetic waves) by the receiving antenna from the target object. Various embodiments of the present disclosure are described hereinafter with reference to FIGS. 1A-1B to FIG. 12.

FIG. 1A illustrates a top view of an example representation of a patch array antenna 1A, in accordance with a first embodiment of the present disclosure. The patch array antenna 1A is equipped with a dielectric substrate 2 and a plurality of antenna elements 3a formed on a first main surface of the dielectric substrate 2. The plurality of antenna elements 3a (where individual antenna elements are referred to as an antenna element 3) is not limited to the example shown in FIG. 1A, other configurations of the plurality of antenna elements 3a are also possible. A grounded conductor plate (not shown in FIG. 1A) is provided on a second main surface opposite to the first main surface of the dielectric substrate 2.

The patch array antenna 1A is a series feeding type patch array antenna, and the plurality of antenna elements 3a that are arranged in the first direction L and connected in series via a feeder line 4. Hereafter, the direction in which the plurality of antenna element 3a is arranged is referred to as “longitudinal direction L”, “array direction L”, “direction L” or “first direction”. The direction perpendicular to the first direction L and parallel to the main surface of the dielectric substrate 2 is referred to as “width direction W”, “direction W” or “second direction W”. It should be noted that the array direction L is hereinafter referred to as a first direction L and the width direction W is hereinafter referred to as a second direction W.

The plurality of antenna elements 3a and the feeder line 4 are formed, for example, by photolithographic patterning of a metal foil provided on the dielectric substrate 2. For this reason, the plurality of antenna elements 3a and the feeder line 4 are integrated. Hereafter, the plurality of antenna elements 3a and the feeder line 4 are sometimes included and referred to as “antenna pattern”.

A feeding point 5 is provided in the center of the first direction L of the antenna pattern. Specifically, the total number of the plurality of antenna elements 3a (herein after an individual antenna element is referred to as antenna element 3) is an even number, and thus a feeding point 5 is provided in the feeder line 4 formed between centered antenna elements. Not limited to this, the feeding point 5 may also be provided at one end of the first direction L of the antenna pattern. As shown in FIG. 1A, the plurality of antenna elements 3a are connected with the feeding point 5 respectively, via an input terminal 41 and an output terminal 42.

FIG. 1B is an enlarged view of the antenna element 3 with feeder lines 4a and 4b, and Input/Output (I/O) terminals 41 and 42 of example representation of FIG. 1A, in accordance with the first embodiment of the present disclosure. The feeder lines 4a and 4b may extend diagonally to the first direction L. As shown in FIG. 1B, the antenna element 3 has a shape that is line symmetry about the centerline (symmetry line) C extending to the first direction L. In other words, the centerline C passes through the center of the second direction W of the antenna element 3. In three-dimensional representation, the centerline C can also be said to be a plane of symmetry perpendicular to the second direction W.

The two feeder lines 4a and 4h are connected to the antenna element 3 at both ends. It should be noted that, referring to FIG. 1A, the ends of the feeder line 4 are not connected to the antenna element 3 and between the ends of the feeder line 4 an even number of the plurality of antenna elements 3a are connected. Referring to FIG. 1B, the feeder line 4a near the feeding point 5 serves as the input terminal 41, and the other feeder line 4b far from the feeding point 5 serves as the output terminal 42. Only the input terminal 41 is connected to the antenna element 3 at the end.

Specifically, the antenna element 3 is formed in a rectangular shape with two sides 31 and 32 extending along the first direction L and two sides 33 and 34 extending along the second direction W. The input terminal 41 is connected to the side 33 of the two sides 33 and 34 extending along the second direction W. The output terminal 42 is connected to the side 34 of the two sides 33 and 34 extending along the second direction W. As the design of the patch array antenna 1A is made in the first direction L from the feeding point 5 to the end of the patch array antenna 1A, the weighting of the quantity of radiation of each antenna element 3 can be easily controlled.

In this embodiment, in at least one antenna element 3, at least one of the input terminal 41 and the output terminal 42 are connected to a position that is eccentric to the centerline C of the antenna element 3. Further, the input terminal 41 and the output terminal 42 are connected to different positions in the second direction W of the antenna element 3.

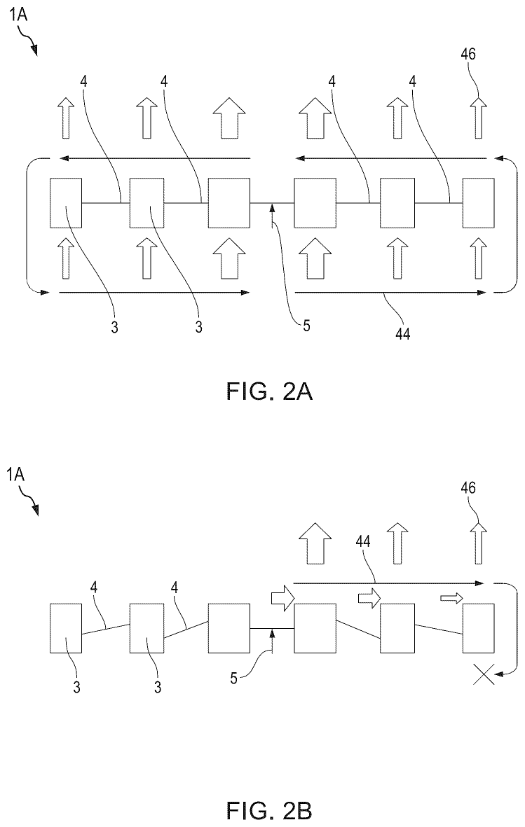

FIG. 2A illustrates a schematic diagram showing the working of the patch array antenna 1A of standing wave type, in accordance with the first embodiment of the present disclosure. The patch array antenna 1A of a standing wave type having the plurality of antenna elements 3a (individual antenna element is referred to as antenna element 3) are connected in series via the feeder line 4 passing on the centerline C. FIG. 2A shows the propagation of an electromagnetic wave 44 fed from the center of the antenna pattern.

The electromagnetic wave 44 powered from the center of the antenna pattern travels toward the edge and some of the electromagnetic wave 44 radiates at the antenna element 3. Also, the electromagnetic wave 44 reflects at the edge of the antenna pattern and travels again toward the center and some of the electromagnetic wave 44 radiates at the antenna element 3. This reciprocating electromagnetic wave 44 process repeats, resulting in radiation 46 from the patch array antenna 1A. The patch array antenna 1A as shown in FIG. 2A is called a standing wave because the electromagnetic wave 44 traveling from the center to the edge overlaps with the electromagnetic wave 44 reflecting at the edge and returning to the center. This requires that the electromagnetic wave 44 coming from the right and the one coming from the left radiate equally when viewed by a single antenna element 3, so the feeder line 4 connected to the antenna element 3 is formed on the centerline C.

The problem with the patch array antenna 1A of standing wave type has been attributed to its designability. In other words, it is difficult to control the weighting of the quantity of radiation 46 because it works for both electromagnetic waves 44 coming from the right and those coming from the left. When the number of arrays is small, extreme weighting is required because of the repetition of the track width. This may change the amount of phase shift of the antenna element 3, and hence the patch array antenna 14 of standing wave type needs to be adjusted to compensate for the phase shift.

FIG. 2B illustrates a schematic diagram showing the working of the patch array antenna 1A of FIG. 1A, in accordance with the first embodiment of the present disclosure. As shown in FIG. 213, the electromagnetic wave 44 traveling from the center of the antenna pattern to the edge radiates all at the antenna element 3 and is not returned in the opposite direction. That is, by connecting the input terminal 41 and the output terminal 42 to the antenna element 3 (as described in FIG. 1B), the quantity of radiation 46 at the antenna element 3 and the amount transmitted from the output terminal 42 to the lower stage can be controlled in a one-way manner for the electromagnetic wave 44 input from the input terminal 41.

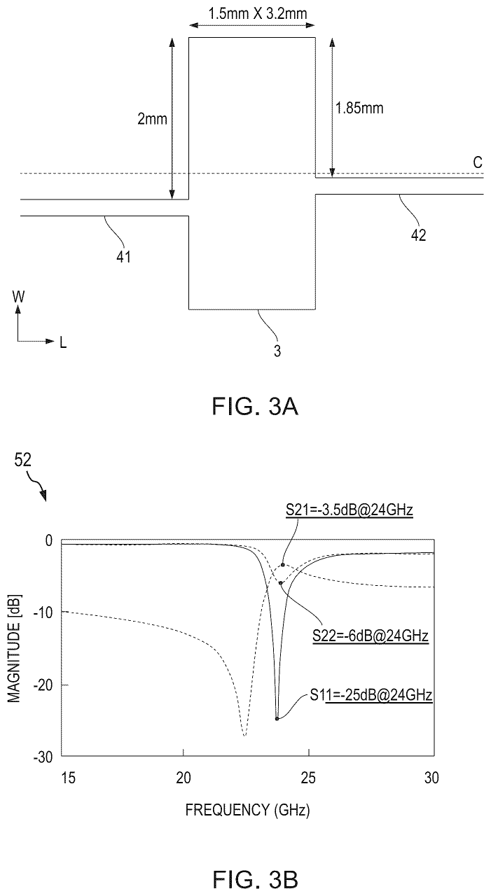

FIG. 3A illustrates an enlarged view of an example representation of antenna element 3 connecting with the feeder line 4, and input/output terminals 41 and 42, in accordance with the first embodiment of the present disclosure. FIG. 3B illustrates a graph 52 showing frequency characteristics of the plurality of antenna elements 3a of FIG. 1A, in accordance with the first embodiment of the present disclosure. In the graph 52, S11 represents a magnitude of −25 decibel (dB), S21 represents a magnitude of −3.5 dB at a frequency of 24 gigahertz (GHz) and S22 represents magnetite of −6 dB. As shown in FIG. 3A, by shifting the positions of the input terminal 41 and the output terminal 42 connected to the antenna element 3 from the centerline C, the electromagnetic wave 44 entering from the input terminal 41 at the frequency of 24 GHz is fed to the antenna element 3 almost without reflection (S11=−25 dB) and −3.5 dB (S21=−3.5 dB) of energy is output to the output terminal 42, as shown in FIG. 3B. On the other hand, the amount of the electromagnetic wave 44 entering from the output terminal 42 (i.e., reverting) is reduced (S22=−6 dB). This indicates that it is possible to design the entire the patch array antenna 1A in a single, one-way design without considering the effects of reflection into account.

In the patch array antenna 1A as shown in the FIG. 2A, the input and output terminals 41 and 42 are connected on the centerline C of the antenna element 3, and the reflection coefficients match between the traveling direction of the electromagnetic wave 44 and the opposite direction. While considering the consistency on the input side, the consistency on the output side must also be considered, this may make the design of the patch array antenna 1A difficult. The excellent designability of the patch array antenna 1A can be achieved as shown in FIG. 2B.

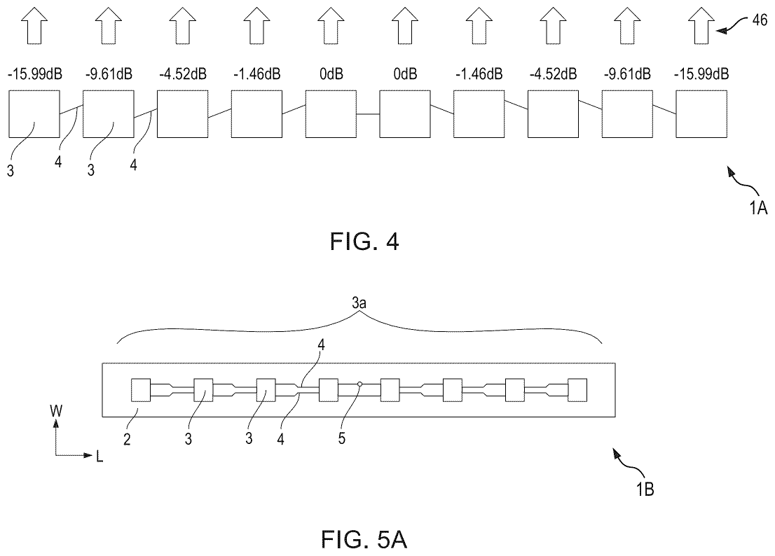

FIG. 4 illustrates a top view of another example representation of the patch array antenna 1A, in accordance with a first embodiment of the present disclosure. For example, if an antenna with a beam width of 10 degrees and a side lobe level of −40 degrees is designed with ten antenna elements (individual antenna element is referred to as antenna element 3), it functions as patch array antenna 1A by weighting the quantity of radiation 46 as shown in the FIG. 4.

It should be noted that the antenna element 3 shown in the FIG. 2A usually consists of a half-wavelength antenna and generates an electromagnetic wave of a plane of polarization parallel to the first direction L. The problem, in this case, is that when the power is supplied from the center of the patch array antenna 1A, a phase difference of ISO degrees from left to right is required, that is, a phase shifter composed of meander lines or the like is required at the center. In high-frequency bands such as 24 GHz and 76 GHz, radiation by a phase shifter becomes a problem because radiation is easily emitted from the bending of the line or the like.

On the other hand, according to the present embodiment, it is possible to design the whole patch array antenna 1A in a single and one-way design without considering the influence of reflection as described above, so it is easy to design it to generate the electromagnetic wave of the plane of polarization perpendicular to the first direction L, which makes it possible to eliminate the phase shifter.

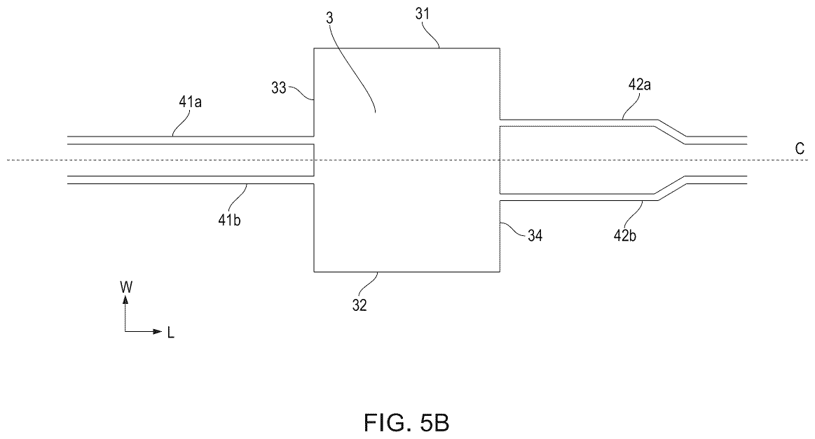

FIG. 5A illustrates a top view of an example representation of a patch array antenna 1B, in accordance with a second embodiment of the present disclosure. The plurality of antenna elements 3a is shown in FIG. 5A. FIG. 5B illustrates an enlarged view of the antenna element 3 with the feeder line 4 represented in 5A, in accordance with the second embodiment of the present disclosure. The detailed explanation may be omitted by giving the same number to the configuration that overlaps with the FIG. 1 to FIG. 4.

In this embodiment, two input terminals 41a and 41b, and two output terminals 42a and 42b are connected to antenna element 3 (except antenna element 3 at the end). Only two input terminals 41a and 41b are connected to antenna element 3 at the end.

Specifically, antenna element 3 is formed in a rectangular shape, and the two input terminals 41a and 41b are connected to one side 33 of two sides 33 and 34 extending along the second direction W, and the two output terminals 42a and 42b are connected to the side 34 of two sides 33 and 34.

Not limited to this, there may be three or more input terminals 41a, 41b, and so on, and three or more output terminals 42a, 42b, and so on.

In this embodiment, at least one of the two input terminals 41a and 41b and the two output terminals 42a and 42b (all terminals in the illustrated example of FIG. 5B) are connected to a position that is eccentric to the centerline C of the antenna element 3. In addition, the two input terminals 41a and 41b and the two output terminals 42a and 42b are connected to different positions in the second direction W of the antenna element 3.

In addition, one of the two input terminals 41a and 41b (i.e., the input terminal 41a) is connected to a position that deviates from the centerline C in one (first side) of the second direction W, and the other input terminal 41b is connected to a position that deviates from the centerline C in the other (second side) of the second direction W. That is, the two input terminals 41a and 41b are connected to both sides of the second direction W to sandwich the centerline C.

More specifically, the two input terminals 41a and 41b are connected at a position where the line symmetry occurs with respect to the centerline C. Even when the two input terminals 41a and 41b are an even number of four or more, they are preferably connected at a position where the line symmetry occurs with respect to the centerline C. In addition, the shape itself of the two input terminals 41a and 41b is also line symmetry with respect to the centerline C.

Similarly, one of the two output terminals 42a and 42b (i.e., the output terminal 42a), is connected to a position that deviates from the centerline C in one (first side) direction in the second direction W, and the other output terminal 42b is connected to a position that deviates from the centerline C in the other (second side) direction in the second direction W. That is, the two output terminals 42a and 42b are also connected to both sides in the second direction W to sandwich the centerline C.

More specifically, the two output terminals 42a and 42b are also connected at the position where the line symmetry is about the centerline C. Even when the two output terminals 42a and 42b are an even number of four or more, it is preferable to connect at the position where the line symmetry is about the centerline C. In addition, the shape itself of the two output terminals 42a and 42b is also line symmetry about the centerline C.

The two input terminals 41a and 41b may be connected more inside the second direction W than the two output terminals 42a and 42b as shown in FIG. 5B, or conversely, outside the second direction W. In other words, the two output terminals 42a and 42b may be connected more outside the second direction W than the two input terminals 41a and 41b, or they may be connected more inside the second direction W.

Without limitation, the two input terminals 41a and 41b, and the two output terminals 42a and 42b may be alternately connected along the second direction W.

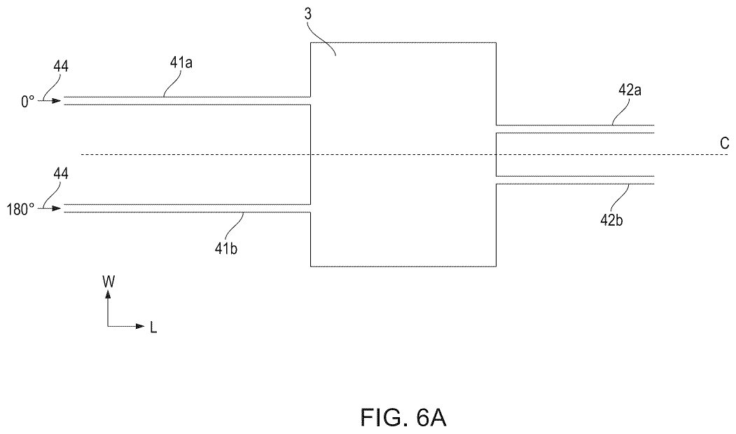

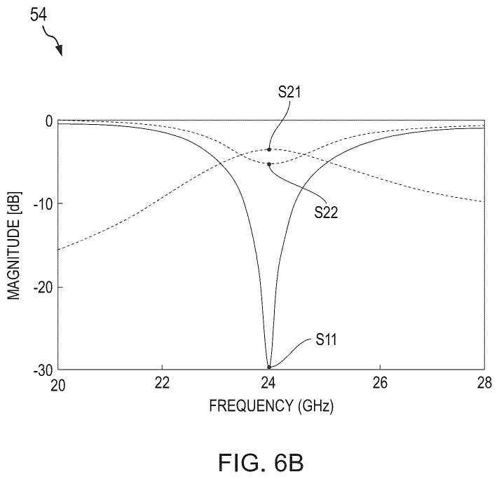

FIG. 6A illustrates an enlarged view of an example antenna element 3 with the feeder line 4, the two input terminals 41a and 41b, and the two output terminals 42a and 42b, in accordance with the second embodiment of the present disclosure. The two input terminals 41a and 41b and the two output terminals 42a and 42b are connected to positions that are out of the centerline C of the antenna element 3 and are in symmetry with respect to the centerline C. As shown in FIG. 6A, the electromagnetic waves 44 with a phase difference of 180 degrees are input to the two input terminals 41a and 41b.

FIG. 6B illustrates a graph 54 showing the frequency characteristics of the plurality of the antenna elements 3a, in accordance with the second embodiment of the present disclosure. The graph 54 shows the sum of the amounts of power output from the two output terminals 42a and 42b when the electromagnetic wave 44 with a phase difference of 180 degrees is input to the two input terminals 41a and 41b in FIG. 6A as the frequency characteristic of the scattering matrix. S11 represents a magnitude of −25 dB, S21 represents a magnitude of −3.5 dB at a frequency of 24 GHz and S22 represents magnetite of −6 dB. In FIG. 6B there is no trap near the center frequency and the band is wider compared to the first embodiment (FIG. 3B), which has one input terminal 41 and one output terminal 42 as shown in FIG. 3B.

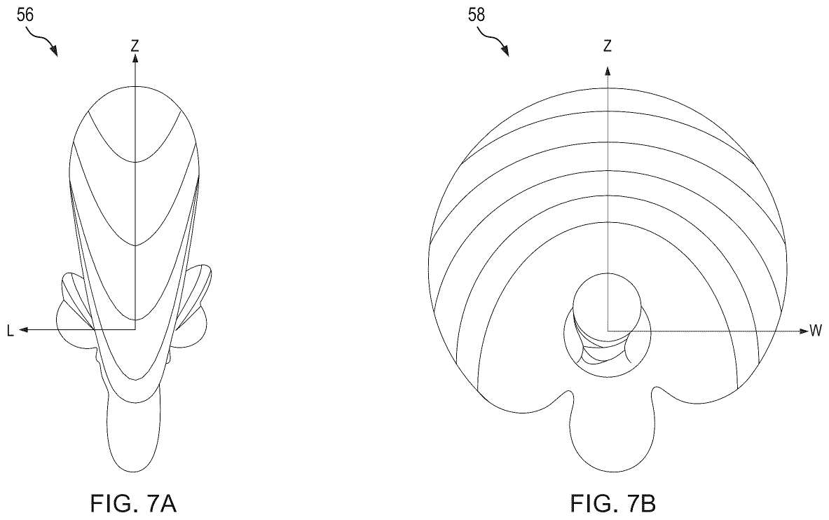

FIGS. 7A and 7B show the calculation results of the directivity of the eight-stage patch array antenna 1B shown in FIG. 5A. In the figure, Z represents the “normal direction Z” of the main surface of the dielectric substrate 2, which is perpendicular to the array direction L and the width direction W. In FIG. 7A, it can be seen that the patch array antenna 1B has a directivity in which the spread of the array direction L is suppressed.

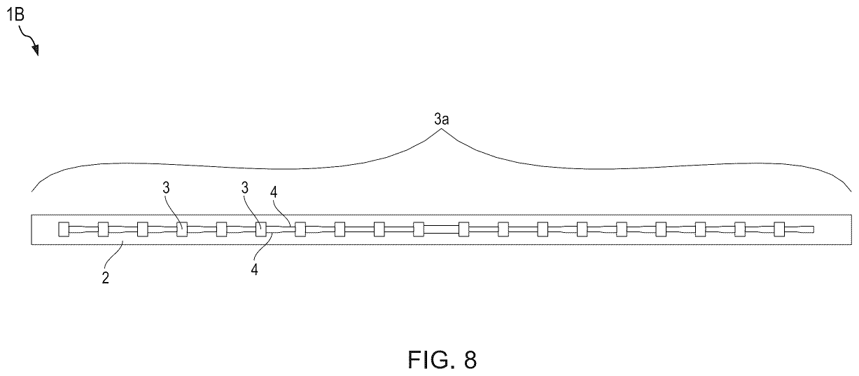

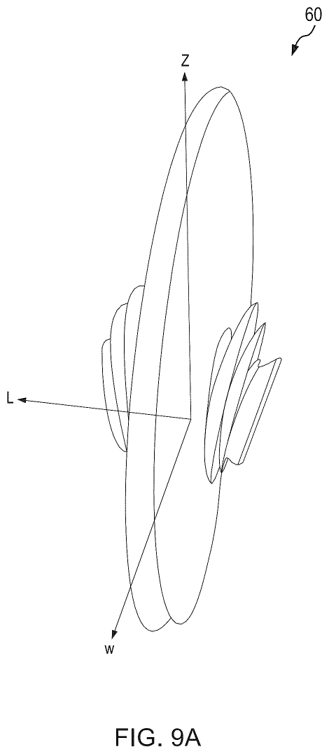

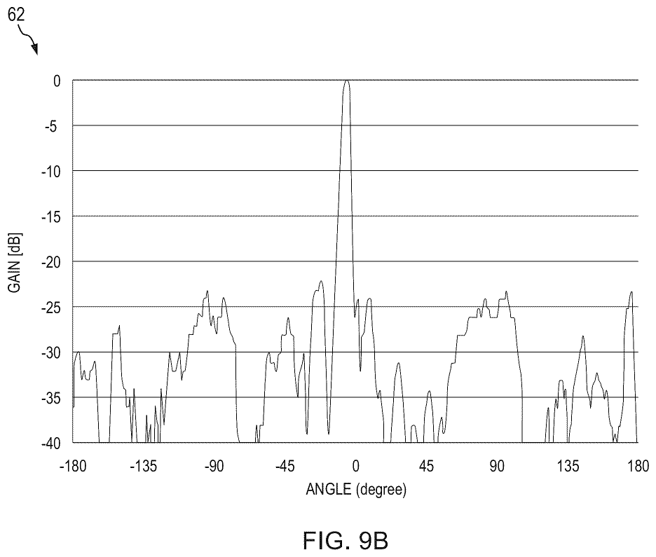

FIG. 8 illustrates a top view of an example representation of the patch array antenna 1B, in accordance with a second embodiment of the present disclosure. The patch array antenna 1B is a ten-stage patch array antenna 1B consisting of ten antenna elements 3 the plurality of antenna elements 3a is ten). FIG. 9A illustrates a calculation result 60 of the directivity of the ten-stage patch array antenna 1B shown in FIG. 8, in accordance with the second embodiment of the present disclosure. FIG. 9B illustrates a graph 62 showing the frequency characteristics of the plurality of antenna elements 3a of FIG. 8, in accordance with the second embodiment of the present disclosure. It should be noted that the patch array antenna 1B achieves the directivity of the beam width of five degrees in the first direction L.

In order to eliminate the need for a phase shifter as described above, it must be designed to generate the electromagnetic waves of a plane of polarization perpendicular to the first direction L. In this case, when the plurality of antenna elements 3a are connected by a single line, it becomes easy for the antenna element 3, which is a half-wavelength antenna, to excite both even and odd modes. As a result, it is difficult to design such a patch army antenna 1B.

An enlarged view of the antenna element 3 with the feeder line 4 of the patch array antenna 1B as shown in FIG. 5A is the same and applicable to the patch array antenna 1B as shown in FIG. 8, Therefore, as in the embodiment of FIG. 8, the two input terminals (e.g., the two input terminals 41a and 41b shown in FIG. 5B), and the two output terminals (e.g., the two output terminals 42a and 42b shown in FIG. 5B) are connected to positions where a line symmetry occurs with respect to the centerline C of the antenna element 3, and an electromagnetic wave of reverse phase is input to the two input terminals 41a and 41b to excite the reverse phase. This enables antenna element 3 to function in a single even mode, thereby suppressing characteristic determination due to the mixed mode of the plurality of antenna elements 3a and improving the designability of the patch army antenna 1B.

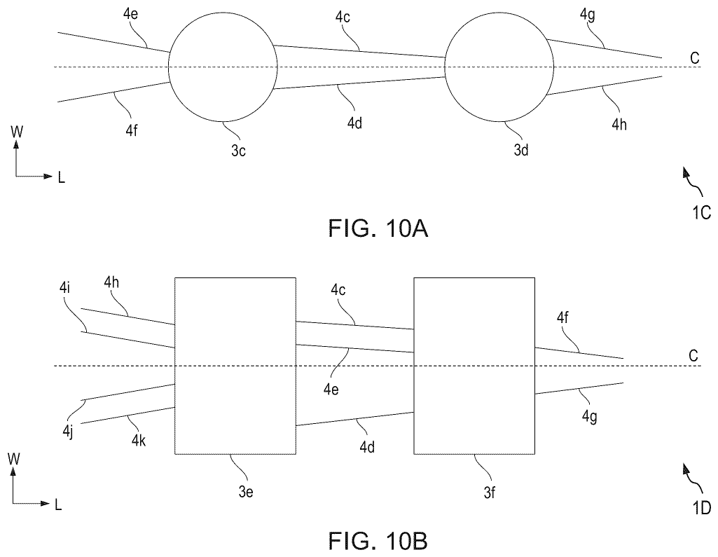

FIG. 10A illustrates a top view of an example representation of a patch array antenna 1C, in accordance with a preferred embodiment of the present disclosure. As shown, antenna elements 3c and 3d are circular in shape but can take other shapes, for example not limited to, rectangular, square, etc. As a result, it is expected that sensitivity to horizontal polarization will be improved. It should be noted that the number of feeder lines 4c and 4d intervening with the antenna elements 3c and 3d is two. Feeder lines 4e and 4f are connected to the antenna element 3c and feeder lines 4g and 4h are connected to the antenna element 3d. The feeder lines 4c, 4d, 4e, 4f, 4g, and 4h may extend parallelly to the first direction L as shown in FIG. 10A. As shown, the antenna elements 3c and 3d have a shape that is line symmetry about the centerline (symmetry line) C extending to the first direction L. In other words, the centerline C passes through the center of the second direction W of the antenna elements 3c and 3d In three-dimensional representation, the centerline C can also be said to be a plane of symmetry perpendicular to the second direction W.

FIG. 10B illustrates a top view of another example representation of a patch array antenna 1D, in accordance with a preferred embodiment of the present disclosure. As shown, the number of feeder lines 4c and 4d intervening with the antenna elements 3c and 3d is not limited to two, but it may be three or four.

Further, as shown in the FIG. 10B, antenna elements 3e and 3f are rectangular in shape. The number of feeder lines 4c, 4d, and 4e intervening with the antenna elements 3e and 3f are three. The feeder lines 4f and 4g are connected to the antenna element 3f and the feeder lines 41i, 4i, 4j, and 4k are connected to the antenna element 3e. More specifically, the antenna element 3f is connected with the two feeder lines 4f and 4g on one side and three feeder lines 4c, 4d, and 4e on the other side. The antenna element 3e is connected with four feeder lines 4h, 4i, 4j, and 4k on the one side and with three feeder lines 4c, 4d, and 4e on the other side. As shown in FIG. 10B, the antenna elements 3e and 3f have a shape that is line symmetry about the centerline (symmetry line) C extending to the first direction L. In other words, the centerline C passes through the center of the second direction W of the antenna elements 3e and 3f. In three-dimensional representation, the centerline C can also be said to be a plane of symmetry perpendicular to the second direction W. Thus, the feeder lines 4c, 4d, 4e, 4f, 4g, 4h, 4i, 4j, and 4k intervening with the antenna elements 3e and 3f are preferably, but not limited to, connected at a position where the line symmetry is about the centerline C.

Thus, the number and different positions of the input terminal (not shown in FIG. 10B) and the output terminal (not shown in FIG. 10B) of the patch array antenna 1D allow easy control of the weighting of the quantity of radiation of each antenna element and suppress characteristic determination of antenna elements 3e and 3f by mixed mode.

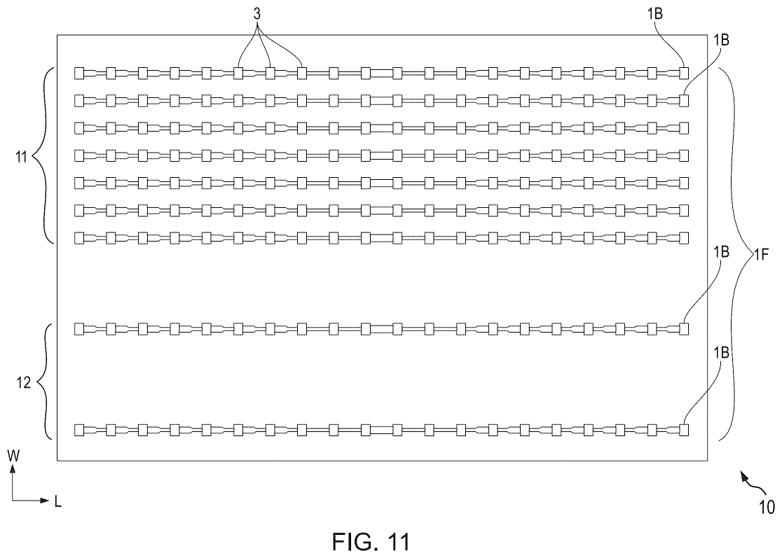

FIG. 11 illustrates an example representation of an antenna 10, in accordance with a preferred embodiment of the present disclosure. The antenna 10 is formed using a plurality of patch array antennas 1F. As shown, the plurality of patch array antennas 1F is formed using the patch array antenna 1B shown in FIG. 5A. It should be noted that the antenna 10 formed using the plurality of patch array antennas 1F includes one or more of the patch array antennas 1A, 1B, 1C, and 1D. The antenna 10 equipped with the plurality of patch array antennas 1F is arranged in a direction perpendicular to the first direction L of the antenna element 3.

In the illustrated example, the antenna 10 is equipped with a receiving antenna 11 containing six patch array antennas 1B and a transmitting antenna 12 containing two patch array antennas 1B. The antenna 10 of this embodiment is suitable as an antenna for multi-kaput Multi-Output (MIMO) RADAR.

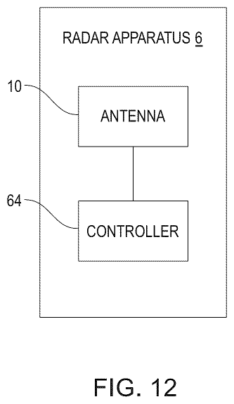

FIG. 12 illustrates an example representation of a RADAR apparatus 6, in accordance with a preferred embodiment of the present disclosure. The RADAR apparatus 6 is formed using the antenna 10 (e.g., the antenna 10 as depicted in FIG. 11). The RADAR apparatus 6 is equipped with the antenna 10 and a controller 64. The receiving antenna 11 (see, FIG. 11) converts the reflected electromagnetic wave into an electrical signal and outputs the electrical signal to the controller 64. The controller 64 controls one or more detection and ranging operations of the RADAR apparatus 6, based on the electromagnetic waves received by the receiving antenna 11.

The RADAR apparatus 6 in this embodiment is the MIMO RADAR that can perform beamforming to enhance directivity in a predetermined direction.

As described above, the present invention is not limited to the embodiment described above, and it is of course possible for those skilled in the art to make various modifications.

What is claimed is:

1. A patch array antenna, comprising:
a dielectric substrate; and
a plurality of antenna elements formed on the dielectric substrate, arranged in a first direction, and connected in series,
wherein at least one terminal of at least one input terminal and at least one output terminal connected to at least one antenna element of a plurality of antenna elements is connected at a position outside the centerline extending in the first direction of the at least one antenna element.

2. The patch array antenna of claim 1, wherein the at least one input terminal and the at least one output terminal are connected at different positions in a second direction perpendicular to the centerline.

3. The patch array antenna of claim 1, wherein the at least one input terminal and the at least one output terminal are connected at a position eccentric to the centerline.

4. The patch array antenna of claim 1, wherein the at least one input terminal is two or more input terminals, and the at least one output terminal is two or more output terminals.

5. The patch array antenna of claim 4, wherein a part of the two or more input terminals is connected to a position that is eccentric to the first side from the centerline, and the remaining input terminals are connected to a position that is eccentric to the second side opposite to the first side from the centerline.

6. The patch array antenna of claim 4, wherein a part of the two or more output terminals are connected to a position that is eccentric to the first side from the centerline, and the remaining output terminals are connected to a position that is eccentric to the second side opposite to the first side from the centerline.

7. The patch array antenna of claim 4, wherein the two or more input terminals are even-numbered input terminals, and the even-numbered input terminals are connected at a position that is line symmetry with respect to the centerline.

8. The patch array antenna of claim 4, wherein the two or more output terminals are even-numbered output terminals, and the even-numbered output terminals are connected at a position that is line symmetry with respect to the centerline.

9. The patch array antenna of claim 4, wherein the two of the two or more input terminals are input with an electromagnetic wave of a reverse phase.

10. The patch array antenna of claim 9, wherein the patch array antenna generates the electromagnetic wave of a plane of polarization perpendicular to the first direction.

11. The patch array antenna of claim 9, wherein the two or more input terminals are input with the electromagnetic wave of the reverse phase to excite the reverse phase.

12. An antenna, comprising:
a transmitting antenna for transmitting electromagnetic waves around a Radio Detecting and Ranging (RADAR) apparatus; and
a receiving antenna for receiving reflected electromagnetic waves reflected from one or more objects,
at least one or more of a plurality of patch array antennas forms at least one of the transmitting antenna and the receiving antenna,
each of the plurality of patch array antennas comprising:
a dielectric substrate; and
a plurality of antenna elements formed on the dielectric substrate, arranged in a first direction, and connected in series,
wherein at least one terminal of at least one input terminal and at least one output terminal connected to at least one antenna element of the plurality of antenna elements is connected at a position outside the centerline extending in the first direction of the at least one antenna element, and
wherein the plurality of patch array antennas is arrayed in a second direction perpendicular to the first direction of the at least one antenna element.

13. A Radio Detecting and Ranging (RADAR) apparatus, comprising:
an antenna comprising:
a transmitting antenna for transmitting electromagnetic waves around the RADAR apparatus; and
a receiving antenna for receiving electromagnetic waves reflected from one or more objects; and
a controller for controlling one or more detection and ranging operations of the RADAR apparatus based on the reflected electromagnetic waves received by the receiving antenna,
wherein at least one of the transmitting antenna and the receiving antenna is formed using at least one or more of a plurality of patch array antennas,
each of the plurality of patch array antennas comprising:
a dielectric substrate; and
a plurality of antenna elements formed on the dielectric substrate, arranged in a first direction, and connected in series,
wherein at least one terminal of at least one input terminal and at least one output terminal connected to at least one antenna element of the plurality of antenna elements is connected at a position outside the centerline extending in the first direction of the at least one antenna element,
wherein the plurality of patch array antennas is arrayed in a second direction perpendicular to the first direction of the at least one antenna element.
